(19) United States
(12) Patent Application Publication
(10) Pub. No.: US 2012/0298930 A1
(43) Pub. Date: Nov. 29, 2012

(54) NANOSTRUCTURE COMPOSITIONS, COATINGS, AND FILMS

(76) Inventor: Chaofeng Zou, Maplewood, MN (US)

(21) Appl. No.: 13/406,560

(22) Filed: Feb. 28, 2012

Related U.S. Application Data
(60) Provisional application No. 61/488,877, filed on May 23, 2011.

(51) Int. Cl. H01B 1/22; B82Y 30/00

(52) U.S. Cl. 252/514; 252/512; 977/779; 977/783; 977/762; 977/810; 977/932

(57) ABSTRACT

Stable multicomponent coating systems with superior coatability and stability are disclosed. Such stable coating systems comprising nanostructures, cellulosic polymers, and blocked isocyanates provide coatings and films exhibiting superior surface resistivity and crosslinking.

### CROSS REFERENCE TO RELATED APPLICATIONS

This application claims the benefit of U.S. Provisional Application No. 61/488,877, filed May 23, 2011, entitled NANOPARTICLE COMPOSITIONS, COATINGS, AND FILMS, which is hereby incorporated by reference in its entirety.

### SUMMARY

Some embodiments provide compositions comprising at least one nanostructure comprising at least one metal, at least one cellulosic polymer comprising at least one hydroxyl group, at least one solvent comprising at least one of a protic solvent, an alcohol, or a ketone; and at least one compound comprising at least one isocyanate moiety and at least one blocking group. The at least one nanostructure may, for example, comprise at least one nanowire, nanocube, nanorod, nanopyramid, nanotube, nanoring, or the like. In at least some embodiments, the at least one nanostructure may comprise at least one coinage metal or at least one element from IUPAC Group 11, such as, for example, silver. Some such compositions may comprise at least one silver nanowire. The at least one cellulosic polymer may, for sample, comprise at least one cellulose ester or cellulose ether, such as, for example, cellulose acetate butyrate. In at least some embodiments, the at least one compound comprises at least one blocking group capable of deblocking at a temperature less than about 150° C., or less than about 140° C. That at least one compound may, for example, comprise at least one of an oxime, a pyrazole, a secondary amine, a malonate, or an alcohol. Or the compound may, for example, comprise at least one of a pyrazole, a secondary amine, or a malonate. In some cases, the at least one solvent comprises at least one alcohol or ketone, such as, for example at least one of isopropanol or methyl ethyl ketone.

Still other embodiments provide coatings formed by the curing of such compositions. Such curing may, for example, be performed at a temperature less than about 150° C., or less than about 140° C., or from about 120° C. to about 135° C.

Yet other embodiments provide films comprising such coatings, where the coatings are disposed on substrates. Such substrates are preferably transparent. Such films may, for example, have surface resistivities less than about 150 ohm/square, or from about 70 ohm/square to about 85 ohm/square. Such films are preferably transparent.

Yet still other embodiments provide devices comprising such films. Such devices may, for example, comprise touch screens, EMI shielding, electrochromic devices, light emitting diode arrays, photovoltaic solar panels, and the like.

These and other embodiments may be understood from the detailed description, exemplary embodiments, examples, and claims that follow.

### DESCRIPTION

All publications, patents, and patent documents referred to in this application are incorporated by reference herein in their entirety, as though individually incorporated by reference.

U.S. Provisional Application No. 61/488,877, filed May 23, 2011, entitled NANOPARTICLE COMPOSITIONS, COATINGS, AND FILMS, is hereby incorporated by reference in its entirety.

### Introduction

Random metal nanowire based transparent conductive films have attracted great attention recently due to their excellent electric conductivity, high light transmittance, and ease of manufacturing on a flexible substrate. The transparent conductive film prepared through the networking of silver nanowires has the potential to replace indium tin oxide as a transparent conductor in many applications, such as touch screens, EMI shielding, electrochromic devices, LED lighting, or photovoltaic solar panels. Transparent conductive films prepared from silver nanowires in organic binders may produce materials with electric resistivity as low as, for example, 10 ohm/sq with total light transmittance of, for example, 80% or higher when coated on a flexible plastic substrate. Surface resistivities may be measured using an R-CHEK RC2175 four-point surface resistivity meter. Total light transmittance may be measured in accordance with ASTM method D-1003 using a BYK Gardner HAZEGARD instrument.

In general, such transparent conductive films can be prepared via conventional coating technologies, such as, for example, spray painting, dip-coating, spin-coating, knife coating, Mayer rod coating, roll coating, gravure coating, slot-die coating, slide coating, curtain coating, other extrusion coating methods, and the like. For the purpose of achieving ultra-thin conductive layer coatings, Mayer rod, slot-die and gravure coating processes are preferred.

### Coating Composition Challenges

It has also been a great challenge to formulate a stable, multiple-component coating system to simultaneously achieve solution coatability and stability, and to have a polymer binder crosslinking system that can provide a high degree of crosslinking upon drying and thermal curing of the coating layer. Various reactive crosslinkers, such as isocyanates, aldehydes, melamines, and Zn and Ti based Lewis acids, can be used to cross-link polymers comprising at least one hydroxyl group, such as polyvinyl alcohol, aliphatic/aromatic polyols, and cellulose ester polymers that comprise at least one hydroxyl group. Aliphatic isocyanate-based cross linkers may be particularly useful for crosslinking cellulosic polymers to form strong binders. Such cross linkers may exhibit the ability of their isocyanate groups to penetrate cellulose polymer networks, moderate reactivity under ambient temperature, and excellent compatibility with hydroxyl group containing polymers to impact the resulting film hardness, flexibility and clarity.

One of major drawbacks for application of isocyanate compounds to cross link hydroxyl group containing polymers is the reactivity of the isocyanate compounds towards water, alcohols, and other polar protic solvents that may be present in the coating formulations. The reaction of isocyanate with these protic solvents at room temperature can result in substantial loss of available free isocyanate groups to cross link the hydroxyl groups of the polymer binder matrix. To overcome this problem, one may use isocyanates in coating solutions that do not contain protic solvents. However, for coating of transparent conductive films containing metal nanowires and other metallic nanostructures this can post a challenge, since most of metal nanostructures are generally stabilized in aqueous or alcoholic solutions, which then tend to be present in the resulting coating solutions. Coating solutions containing both isocyanate cross linkers and protic solvents thus tend to exhibit poor solution shelf life, as evidenced by the loss of hardness, loss of abrasion resistance and solvent resistance, and loss of conductivity, of films made from aged coating solutions. It is therefore an aim to develop a chemical composition including ingredients that are necessary for producing a conductive film coating, while also maintaining sufficient solution stability to allow manufacture of coatings even after 24 hours of aging.

### Blocked Isocyanates

At least some embodiments provide compositions comprising compounds comprising isocyanate moieties and blocking groups that are capable of deblocking. Such compounds are sometimes referred to as “blocked isocyanates.” The use of blocked isocyanate agents to affect polymer crosslinking is known. See, for example, Z. W. Wicks Jr., Prog. Org. Coat., 1975, 3, 73; Z. W. Wicks Jr., Prog. Org. Coat., 1981, 9, 3; D. A. Wicks, Z. W. Wicks Jr., Prog. Org. Coat., 1999, 36, 148; and D. A. Wicks, Z. W. Wicks Jr., Prog. Org. Coat., 2001, 41, 1, each of which is hereby incorporated by reference in its entirety. The Applicant has found that by introducing blocked isocyanates as cross link agents with cellulosic polymers, the lifetime of the resulting coating solutions for transparent conductive films can be extended significantly without affecting film conductivity or final film physical properties. For example, a coating solution containing silver nanowires, cellulose ester binder, and a blocked isocyanate agent can be stable for up to 48 hours without significant loss of solution properties, even in the presence of protic solvents such as isopropanol.

Several different chemical processes may occur during coating, drying, and curing of the coated film. Such chemical processes may, for example, include deblocking or activating of blocking groups to provide isocyanate cross-linking functionality, transesterification to form cross-links with the binder, and the like. These processes can impact the conductivity of the resulting film. When coating transparent conductive film on a plastic substrate, such as, for example, polyethylene terephthalate (PET), it is preferable that the deblocking temperature be chosen to be below the plastic's softening point, to avoid distortion or shrinkage of the film during the drying/curing processes. Prolonged exposure of the film to temperatures above the plastic's glass transition temperature may result in formation and migration of cyclic oligomers, which can cause deterioration of the optical and electrical properties of the film. In addition, at very high temperatures, the reaction of oxygen with silver nanowire surfaces to form poorly conductive silver oxide may be accelerated; these very high temperatures should therefore be avoided. It is preferred that the deblocking (activating) temperature for the blocked isocyanate to be used in this application be below about 150° C., and more preferably below about 140° C. It is also preferred that the temperature for curing the deblocked isocyanate with the polymer binder containing hydroxyl groups also be below about 150° C., and more preferably below about 140° C.

Examples of blocking groups include alcohols, caprolactams, phenols, oximes, pyrazoles, secondary amines, and malonates. Exemplary minimum deblocking temperatures are 205° C. for alcohols, 195° C. for caprolactams, 170° C. for phenols, 140° C. for oximes, 130° C. for pyrazoles and secondary amines, and 110° C. for malonates. Because of their lower minimum deblocking temperatures, isocyanate compounds containing pyrazoles, secondary amines, and malonates are preferred.

### Cellulosic Polymers

At least some embodiments provide compositions comprising cellulosic polymers, as well as coatings and films made from such compositions. Cellulosic polymers are polysaccharides or derivatives of polysaccharides, that may have degrees of polymerization of, for example, 100, 1000, 10,000, or more. These include derivatives of cellulose, such as, for example, esters and ethers of cellulose. Examples of cellulosic esters include, for example, cellulose acetate, cellulose triacetate, cellulose propionate, cellulose acetate propionate, cellulose acetate butyrate (CAB), and the like. Examples of cellulosic ethers include, for example, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose, and the like. These and other such cellulosic polymers will be understood by those skilled in the art.

### Nanostructures

At least some embodiments provide compositions comprising nanostructures, as well as coatings and films made from such compositions. Nanostructures are structures having at least one “nanoscale” dimension less than 300 nm, and at least one other dimension being much larger than the nanoscale dimension, such as, for example, at least about 10 or at least about 100 or at least about 200 or at least about 1000 times larger. Examples of such nanostructures are nanorods, nanowires, nanotubes, nanopyramids, nanoprisms, nanoplates, nanorings, and the like. “One-dimensional” nanostructures have one dimension that is much larger than the other two dimensions, such as, for example, at least about 10 or at least about 100 or at least about 200 or at least about 1000 times larger. Such nanostructures may, in some cases, comprise coinage metals or elements from IUPAC Group 11, such as, for example, silver, copper, or gold.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in such applications, although copper nanowires are also beginning to be employed.

### Protic Solvents

Some embodiments provide compositions comprising protic solvents, as well as coatings and films made from such compositions. Protic solvents are those that possess dissociable protons (H⁺). Formic acid, acetic acid, alcohols, ammonia, hydrogen fluoride, and water are non-limiting examples of protic solvents.

The Hansen δH hydrogen bonding solvent parameters for protic solvents are generally greater than about 12. The δH parameter for some exemplary protic solvents follow. The δH parameter for acetic acid is 13.5, for n-butanol is 15.8, for isopropanol is 16.4, for n-propanol is 17.4, for ethanol is 19.4, for methanol is 22.3, for formic acid is 14.0, and for water is 42.3.

### Exemplary Embodiments

U.S. Provisional Application No. 61/488,877, filed May 23, 2011, entitled NANOPARTICLE COMPOSITIONS, COATINGS, AND FILMS, which is hereby incorporated by reference in its entirety, disclosed the following 21 non-limiting exemplary embodiments:

A. A composition comprising:
at least one nanoparticle comprising at least one metal;
at least one cellulosic polymer comprising at least one hydroxyl group; and
at least one compound comprising at least one isocyanate moiety and at least one blocking group.

B. The composition according to embodiment A, wherein the at least one nanoparticle comprises at least one nanowire, nanocube, nanorod, nanopyramid, or nanotube.

C. The composition according to embodiment A, wherein the at least one nanoparticle comprises at least one coinage metal or at least one element from IUPAC Group 11.

D. The composition according to embodiment A, wherein the at least one nanoparticle comprises at least one silver nanowire.

E. The composition according to embodiment A, wherein the at least one cellulosic polymer comprises at least one cellulose ester or cellulose ether.

F. The composition according to embodiment A, wherein the at least one cellulosic polymer comprises at least one cellulose ester.

G. The composition according to embodiment A, wherein the at least one cellulosic polymer comprises cellulose acetate butyrate.

H. The composition according to embodiment A, wherein the at least one compound comprises at least one blocking group capable of deblocking at a temperature less than about 150° C.

J. The composition according to embodiment A, wherein the at least one compound comprises at least one blocking group capable of deblocking at a temperature less than about 140° C.

K. The composition according to embodiment A, wherein that at least one compound comprises at least one of an oxime, a pyrazole, a secondary amine, a malonate, or an alcohol.

L. The composition according to embodiment A, further comprising at least one protic solvent.

M. The composition according to embodiment A, further comprising at least one alcohol or ketone.

N. The composition according to embodiment A, further comprising at least one of isopropanol or methyl ethyl ketone.

P. A coating formed by curing the composition according to embodiment A.

Q. The coating according to embodiment P, wherein the curing is performed at a temperature less than about 150° C.

R. The coating according to embodiment Q, wherein the curing is performed at a temperature less than about 140° C.

S. The coating according to embodiment Q, wherein the curing is performed at a temperature from about 120° C. to about 135° C.

T. A transparent conductive film comprising the coating according to embodiment P, wherein the coating is disposed on a transparent substrate.

U. The film according to embodiment T having a surface resistivity less than about 150 ohm/square.

V. The film according to embodiment T having a surface resistivity from about 70 ohm/square to about 85 ohm/square.

W. A device comprising the transparent conductive film according to embodiment T.

### EXAMPLES

### Materials

Unless otherwise noted, materials were available from Sigma-Aldrich, Milwaukee, Wisc.

CAB171-15 is a cellulose acetate butyrate polymer (Eastman Chemical).

DESMODUR® BL1265 MPA/X is a 65% solids dispersion of a blocked aromatic polyisocyanate based on toluene diisocyanate (TDI) in a 1:1 mixture of methoxypropyl acetate-2 and xylene. This polyisocyanate contains caprolactam blocking groups. (Bayer).

DESMODUR® BL3175A is a 75% solids dispersion of a blocked aliphatic polyisocyanate based on hexamethyene diisocyanate (HDI) in aromatic 100. This polyisocyanate contains butanone oxime blocking groups. (Bayer).

DESMODUR® BL3370 MPA is a 70% solids dispersion of a blocked aliphatic polyisocyanate based on hexamethylene diisocyanate (HDI) in propylene glycol monomethyl ether acetate. This polyisocyanate contains diisopropyl amine (DIPA) and alcohol blocking groups. (Bayer).

DESMODUR® BL3475 BA/SN is a 75% solids dispersion of a blocked aliphatic polyisocyanate based on hexamethylene diisocyanate (HDI) and isophrone diisocyanate (IPDI) in a 1:1 mixture of n-butyl acetate and aromatic 100. This polyisocyanate contains alcohol blocking groups. (Bayer).

DESMODUR® N3300 is an aliphatic polyisocyanate (hexamethylene diiosocyanate trimer) (Bayer).

TEGO® GLIDE 410 is a polyether modified polysiloxane (Evonik Tego Chemie).

### Example 1

Coating dispersions were prepared by mixing at room temperature for 2 minutes 100 parts by weight of CAB171-15 cellulose acetate butyrate polymer, 29 parts by weight of either a blocked or unblocked isocyanate, 10 parts by weight of bismuth neodecanoate, 2 parts by weight of TEGO® GLIDE 410 polyether modified polysiloxane, 21 parts by weight of silver nanowires, 333 parts by weight of methyl ethyl ketone, 336 parts by weight of ethyl lactate, and 315 parts by weight isopropanol. Samples from the coating dispersions were set aside for shelf life testing.

The coating dispersions were coated onto 7 mil clear polyethylene terephthalate supports using a #10 Mayer rod. The resulting coatings were dried and cured at various temperatures to obtain transparent films. The films were tested for surface resistivity and the ability to withstand wiping with methyl ethyl ketone wipes, which is a measure of the extent of polymer crosslinking.

Table I shows the results of coating dispersion shelf life testing. For films coated from aged coating dispersions containing an unblocked aliphatic isocyanate (DESMODUR® N3300), conductivity and extent of polymer crosslinking decreased significantly with increasing dispersion age. However, for films coated from aged coating dispersions containing a blocked aliphatic isocyanate (DESMODUR® BL3370 MPA), good conductivity and polymer crosslinking persisted even when using coating dispersions aged for 48 hrs.

Table II shows the effect of cure temperature and identity of blocking group on the extent of polymer crosslinking and surface conductivity of the resulting transparent films. For curing temperatures below 140° C., only the coating composition containing the blocked polyisocyanate possessing secondary amine and malonate blocking groups produced a cured transparent film exhibiting both good surface conductivity and polymer crosslinking.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE I

| | | Dispersion | Surface | Resistance |
|---|---|---|---|---|
| | Blocking | Age | Resistivity | to MEK |
| Compound | Group(s) | (hrs) | (ohm/sq) | Wipe |
| DESMODUR ® | none | 0 | 70 | Good |
| N3300 | | | | |
| DESMODUR ® | none | 24 | 2000 | Poor |
| N3300 | | | | |
| DESMODUR ® | none | 48 | Not | Poor |
| N3300 | | | Conductive | |
| DESMODUR ® | DIPA/alcohol | 0 | 80 | Good |
| BL3370 | | | | |
| DESMODUR ® | DIPA/alcohol | 24 | 90 | Good |
| BL3370 | | | | |
| DESMODUR ® | DIPA/alcohol | 48 | 120 | Good |
| BL3370 | | | | |

TABLE II

| | | | | | Resis- |
|---|---|---|---|---|---|
| | | | Cure | Surface | tance |
| | Blocking | Iso- | Temp | Resistivity | to MEK |
| Compound | Group(s) | cyanate | (° C.) | (ohm/sq) | Wipe |
| DESMODUR ® | DIPA/ | HDI | 107 | Not | Poor |
| BL3370 | alcohol | | | Conductive | |
| DESMODUR ® | DIPA/ | HDI | 121 | 85 | Fair |
| BL3370 | alcohol | | | | |
| DESMODUR ® | DIPA/ | HDI | 135 | 70 | Good |
| BL3370 | alcohol | | | | |
| DESMODUR ® | caprolactam | TDI | 135 | Not | Poor |
| BL1265 | | | | Conductive | |
| DESMODUR ® | MEK | HDI | 135 | Not | Poor |
| BL3175 | oxime | | | Conductive | |
| DESMODUR ® | alcohol | HDI/ | 135 | Not | Poor |
| BL3475 | | IPDI | | Conductive | |

What is claimed:

1. A composition comprising:
at least one nanostructure comprising at least one coinage metal or at least one element from IUPAC Group 11;
at least one cellulosic polymer comprising at least one hydroxyl group;
at least one solvent comprising at least one of a protic solvent, an alcohol, or a ketone; and
at least one compound comprising at least one isocyanate moeity and at least one blocking group capable of deblocking at a temperature less than about 150° C.

2. The composition according to claim 1, wherein the at least one nanostructure comprises at least one silver nanowire.

3. The composition according to claim 1, wherein the at least one cellulosic polymer comprises cellulose acetate butyrate.

4. The composition according to claim 1, wherein the at least one compound comprises at least one blocking group capable of deblocking at a temperature less than about 140° C.

5. The composition according to claim 1, wherein that at least one compound comprises at least one of an oxime, a pyrazole, a secondary amine, a malonate, or an alcohol.

6. The composition according to claim 1, wherein the at least one compound comprises at least one of a pyrazole, a secondary amine, or a malonate.

7. The composition according to claim 1, wherein the at least one solvent comprises at least one alcohol or ketone.

8. A coating formed by curing the composition according to claim 1.

9. A film comprising the coating according to claim 8 and a substrate, wherein the coating is disposed on the substrate.

10. The film according to claim 9 having a surface resistivity less than about 150 ohms/square.
